(19) United States
(12) Patent Application Publication
(10) Pub. No.: US 2012/0329340 A1
(43) Pub. Date: Dec. 27, 2012

(54) JUMPER CABLES AND METHOD

(76) Inventor: Von Hubbard, Harrisville, UT (US)

(21) Appl. No.: 13/170,123

(22) Filed: Jun. 27, 2011

(51) Int. Cl. H01R 4/48

(52) U.S. Cl. 439/759

(57) ABSTRACT

A method and apparatus are disclosed for improving the bite of both traditional jumper cables and jumper cables suffering from spring fatigue. The disclosed system and method teach alligator clips whose bit is strengthened by one or more detachable elastomeric bands wrapped around the jaws of the alligator clips to increase the compressive pressure of the alligator clip against the terminal of car battery or another electrical connection.

### BACKGROUND OF THE INVENTION

1. Field of the Invention

This invention relates to jumper cables, and in particular relates to means of improving the connection between traditional jumper cables and corroded battery terminals.

2. Description of the Related Art

Automotive drivers the world over are forced to deal unexpectedly with dead car batteries and the consequent inability to start their engines. Usually, these car batteries are jump started using jumper cables interconnecting the dead car battery with either a charged car battery or any number of a variety of charging devices or capacitors.

As the positive and negative terminals on car batteries corrode, it becomes increasingly more difficult to effectuate inter-contact between the dead car battery and the charging device which is sufficient to conduct the wattage necessary to jump start the dead battery. Most jumper cables comprise two pairs of heavy alligator clips for gripping the terminals of the dead battery and the charged battery. These alligator clips, in the prior art, comprise increasingly stiff springs which are hoped by their designer to provide heavy enough grip for the serrated jaws of the alligator clips to bite through the corrosion on the battery terminals and form a viable connection with the subject batteries.

Over time the springs in the alligator clips fatigue, reducing the bite of the jaws on the terminals. The prior art appears to teach no means of increasing the compressive force of the jaws against the terminals other than by making use of increasingly stiff springs in the alligator clips.

### SUMMARY OF THE INVENTION

From the foregoing discussion, it should be apparent that a need exists for an apparatus and method for improving the bite of new and fatigued jumper cables. The present invention has been developed in response to the present state of the art; and, in particular, in response to the problems and needs in the art that have not yet been fully solved by currently available methods and apparatii, and that overcome many or all of the above-discussed shortcomings in the art. Accordingly, the present invention has been developed to provide an apparatus and method for improved jumper cables.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention discloses an improved alligator clip comprising: an alligator clip comprising a set of serrated jaws for gripping terminals of battery; and two or more elastomeric bands circumscribing, and partially encapsulating, the jaws of the alligator clip for improving the compressive force of the jaws against the terminals of the battery.

In various embodiments, the two or more detachable elastomeric bands circumscribe the distal ends of the jaws forward of the portion of the jaws used for gripping the battery terminals. In still further embodiments, the two or more elastomeric bands are detachable such that the bands can be removed after becoming fatigued.

In some embodiments, the terminal of the battery is gripped by a portion of the jaws disposed between the two or more elastomeric bands, such that at least one of the elastomeric bands is compressing both sides of the jaws gripping the terminal.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a top perspective view of an improved alligator clip in accordance with the present invention;

FIG. 2 is a top perspective view of improved jumper cables affixed to the terminals of a car battery in accordance with the present invention; and

FIG. 3 is a top perspective view of a second embodiment of improved alligator clips in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

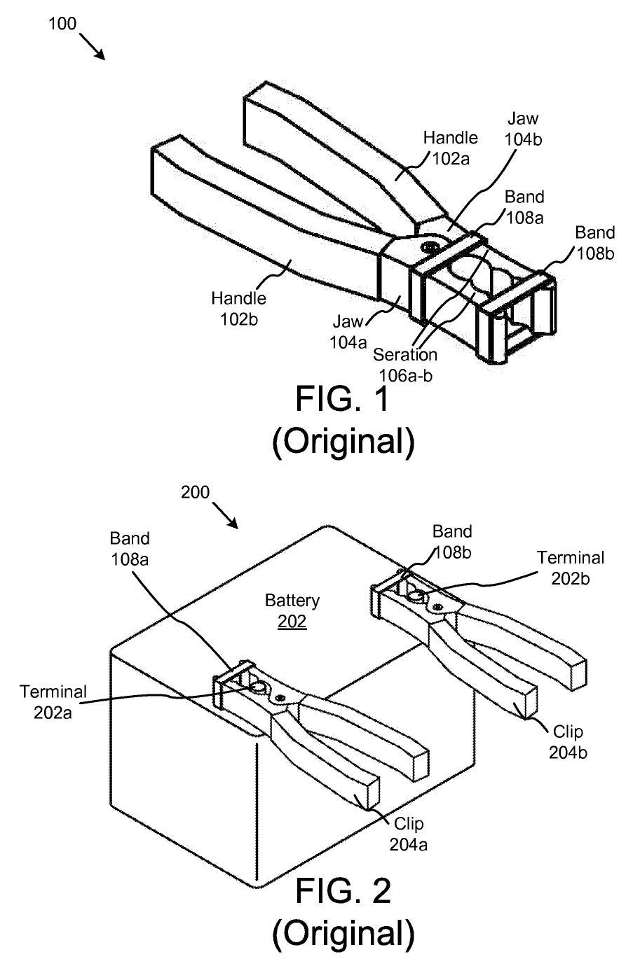

FIG. 1 is a top perspective view of an improved alligator clip 100 in accordance with the present invention. The improved alligator clip 100 comprises a handle 102a, a handle 102b, a jaw 104a, a jaw 104b, a serration 106a, a serration 106b, a band 108a, and a band 108b.

The handle 102a, the handle 102b, the jaw 104a, the jaw 104b, the serration 106a, and the serration 106b all form part of an alligator clip and are known to those of skill in the art. In some embodiments, the improved alligator clip 100 comprises a spring biasing the improved alligator clip 100 into the closed position. In other embodiments, the improved alligator clip 100 does not include a spring.

The bands 108a-b improve the compressive force of the jaws 104a-b against the terminals of a car battery. In the shown embodiment, the improved alligator clip comprises two bands 108a-b. In other embodiments, the improved alligator clip 100 may comprise any number of a plurality of bands 108 oriented side-by-side or overlapping one another.

In various embodiments, the elastomeric bands 108a-b are formed from one or more of elastomeric rubber, leather, twine, surgical tubing, tire shreds, and the like.

In various embodiments, the bands 108a-b are detachably affixed to the jaws 104a-b of the alligator clip 100. In other embodiments, the bands 108a-b adhere to the jaws 104a-b and are permanently affixed to the alligator clip 100.

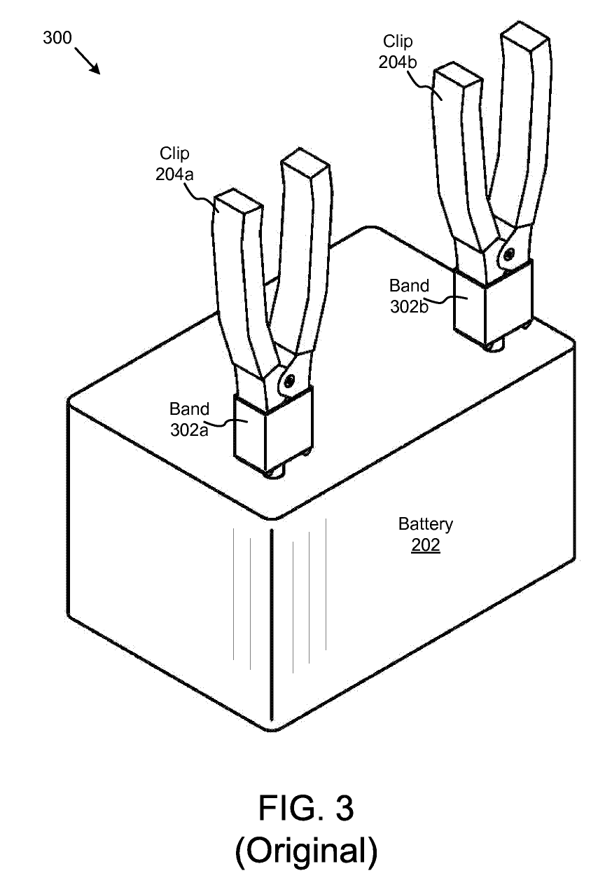

FIG. 2 is a top perspective view of improved jumper cables 200 affixed to the terminals of a car battery in accordance with the present invention.

The alligator clips of the jumper cables 200, in the shown embodiment, comprise only one band 108. This band 108 is positioned toward the forward (i.e. distal) ends of the alligator clips 100a-b. Because the proximal ends of the jaws of the clips 100a-b bite down on the terminals 202a-b of the battery 102, the bands 108a-b provide compression forward of the terminals 202a-b, which is more efficient that compression provided behind the terminals 202a-b. In this manner, the bands 108a-b effectuate a more efficient bite in connection with springs in the alligator clips 100 than the clips 100a-b would on their own.

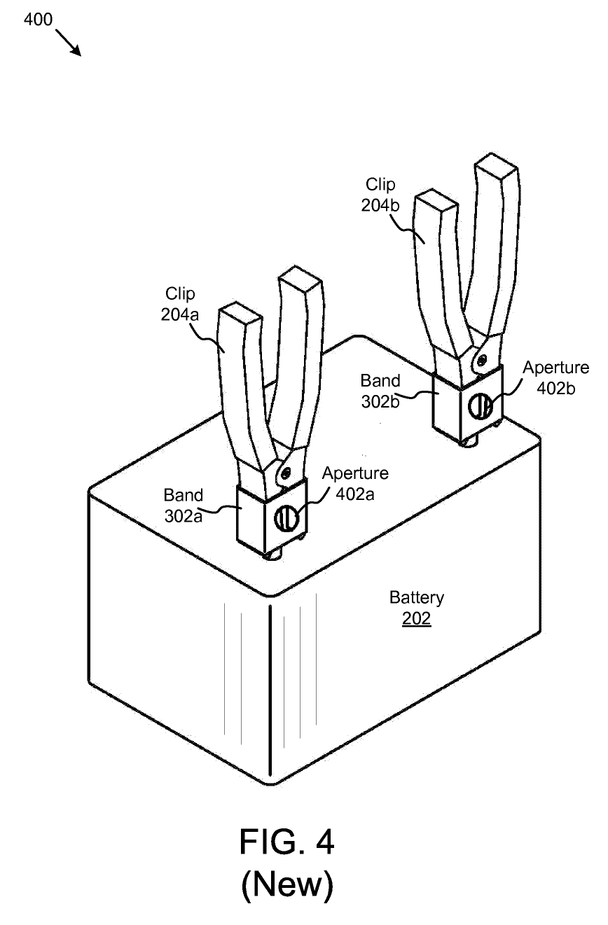

FIG. 3 is a top perspective view of a second embodiment of improved alligator clip 300 in accordance with the present invention.

In various embodiments of the present invention, alligator clips 204a-b are clamped down in a vertical orientation on the terminals 202a-b. In various embodiments, the alligator clips 204a-b are clamped down on the terminals 202a-b in a horizontal orientation.

The bands 302a-b, in the shown embodiment, span the length of the jaws 104a-b. In other embodiments, the bands 302a-b may be folded back over the jaws 104a-b to increase the compressive force of the clips 204a-b against the terminals 202a-b.

In some embodiments, the bands 302a-b comprise holes, or apertures, for receiving the terminals of the battery 202.

The functions of the systems shown in the present invention correspond generally to other systems, methods, apparatii and computer program products outlined in the present invention, and further illustrates the availability of different allocations of functionality amongst modules that implement an embodiment of the invention. To the extent that hardware, software, and firmware implementations are deemed partially or fully interchangeable at the time in question (now or hereafter) by one of skill in the art, they may be utilized in embodying the invention even though the specific implementation examples discussed here are different.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An improved alligator clip comprising:
an alligator clip comprising a set of serrated jaws for gripping terminals of battery;
two or more elastomeric bands circumscribing, and partially encapsulating, the jaws of the alligator clip for improving the compressive force of the jaws against a terminal of the battery;
wherein one or more of the elastomeric bands define apertures for receiving a battery terminal.

2. The improved alligator clip of claim 1, wherein the two or more detachable elastomeric bands circumscribe distal ends of the jaws forward of a portion of the jaws used for gripping the battery terminals.

3. The improved alligator clip of claim 1, wherein the two or more elastomeric bands are detachable such that the bands can be removed after becoming fatigued.

4. The improved alligator clip of claim 1, wherein the terminal of the battery is gripped by a portion of the jaws disposed between the two or more elastomeric bands, such that at least one of the elastomeric bands is compressing both sides of the jaws gripping the terminal.

5. The improved alligator clip of claim 1, wherein one or more of the elastomeric bands are fabricated from one of surgical tubing and tire shreds.
